(19) United States
(12) Patent Application Publication
(10) Pub. No.: US 2006/0086818 A1
(43) Pub. Date: Apr. 27, 2006

(54) FUEL INJECTOR WITH INJECTION COURSE SHAPING BY MEANS OF SWITCHABLE THROTTLE ELEMENTS- -

(76) Inventor: Friedrich Boecking, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/362,013

(22) PCT Filed: Jun. 19, 2002
(86) PCT No.: PCT/DE02/02236

§ 371 Date: Aug. 1, 2003

(30) Foreign Application Priority Data
Jun. 29, 2001 (DE) 10131640.2

(51) Int. Cl. F02M 41/16

(52) U.S. Cl. 239/96; 239/88

(57) ABSTRACT

A fuel injector for injecting fuel into the combustion chamber of an internal combustion engine includes a multi-position valve having a valve body surrounded by a valve chamber received in the injector body. Upon actuation of the multi-position valve, a control chamber is subjected to pressure or is pressure-relieved; the control chamber is subjected to pressure via at least one inlet throttle element and can be relieved of pressure via at least one outlet throttle element. Downstream of the valve chamber on the outlet side is a further outlet throttle element, and the valve chamber and control chamber communicate with one another via a primary flow conduit and a secondary flow conduit.

### FIELD OF THE INVENTION

Increasingly, fuel injection systems in direct-injection internal combustion engines are being embodied as common-rail injection systems. Via a high-pressure pump or a common rail, the individual fuel injectors are supplied, in the injection sequence, with fuel that is at extremely high pressure; the fuel delivery is effected at an extremely high pressure level, virtually without pressure fluctuations. Besides the delivery of fuel at a high, virtually constant pressure level, both the onset and end of the injection dependent on the progress of combustion in the combustion chamber of an internal combustion engine are of great significance with respect to particle emissions.

### PRIOR ART

From German Patent Disclosure DE 199 10 589 A1, an injection valve for an internal combustion engine is known which includes a servo valve that hydraulically closes the opening and closing motions of the nozzle needle for the injection event. The injection valve includes a valve body and a valve element which is movably disposed in the valve body and in the closing position presses against a valve seat. Depending on the pressure prevailing in a control chamber, the communication between an inlet conduit and an injection nozzle is interrupted; the pressure in the control chamber is controlled by an actuator. The valve element has a conduit with a throttle, which leads to a groove in the valve element; the groove surrounds a pistonlike shoulder, which rests essentially sealingly against the wall of a bore in the valve body when the servo valve is closed. At a distance from the upper edge of the groove, relative to the position of the valve element when the servo valve is closed, the bore widens radially in such a way that when the servo valve is open, a direct communication between the valve seat and the groove is brought about, from which conduits lead to the injection nozzle. With this embodiment, in the initial phase of the injection, a throttled communication with the injection nozzle of the injection system can be established. In the further course of the injection event, whenever the servo valve opens farther, a direct unthrottled communication with the injection nozzle is built up, circumventing the throttle that is operative during the initial phase of the injection, so that at the transition from the initial phase to the main phase of the injection event, an unhindered injection of fuel into the combustion chamber of the engine can take place.

European Patent Disclosure EP 0 994 248 A₂ relates to a fuel injector with injection course shaping by means of a nozzle needle stroke in the injector body that takes place piezoelectrically. To avoid unwanted exhaust emissions, at least three different injection rates are desirable, in order to cover the operating range of an internal combustion engine. These injection rates can be characterized by a ramplike ascent, a boot phase, and an approximately trapezoidally extending phase. In the embodiment known from EP 0 994 248 A₂, a fuel injector includes an injector body, which contains an injection opening. A nozzle needle is disposed movably inside the injector body and can be moved between an open position and a closing position. A piezoelectric actuator is also disposed in the injector body and is movable between a switched-on and a switched-off position. By means of a coupling element, the nozzle needle and the piezoelectric actuator are coupled with one another in such a way that the motion of the piezoelectric actuator inside the injector body is converted into a greater stroke motion of the nozzle needle. The nozzle needle can be stopped in many stroke positions between its open and closing positions, which makes it possible to vary the injection quantity, depending on the position where the nozzle needle is stopped in the injector body. With this embodiment, the injection at corresponding injection rates into the combustion chamber and thus a shaping of the injection course can be attained.

### SUMMARY OF THE INVENTION

The embodiment according to the invention offers the advantage of providing the capability of injection course shaping by means of switching outlet throttle elements and inlet throttle elements on and of in combination with a multi-position valve, such as a 3/3-way valve, in a fuel injector.

In a first general variant embodiment, a first outlet throttle element is always connected downstream of the outlet from the valve chamber of the multi-position valve. In this variant, in which the valve chamber of the multi-position valve is in communication, via a primary flow conduit and a secondary flow conduit extending parallel to it, with the control chamber that actuates the nozzle needle, a further outlet throttle element can be accommodated both in the secondary flow conduit and in the primary flow conduit. The inlet throttle element, however, can be disposed either as discharging into the valve chamber of the multi-position valve or as discharging directly into the control chamber, or it can be embodied as discharging into one of the conduits connecting the valve chamber with the control chamber, such as the primary flow conduit.

The filling of the control chamber that actuates the nozzle needle with a control volume always takes place by means of the inlet throttle, which can be disposed at different points in the injector body of the fuel injector. If the further outlet throttle element is embodied with a smaller throttle cross section, compared to the first outlet throttle element connected downstream of the valve chamber of the multi-position valve, then both of these outlet throttle elements can be connected to one another either in series or parallel to one another, for the sake of injection course shaping. Especially good shaping of the injection course can be realized with a first outlet throttle element connected in series with the further outlet throttle element.

Besides the possibility of serial or parallel connection of outlet throttle elements, in a further general variant embodiment of the fundamental concept of the invention it is also possible to realize an injection course shaping, in a fuel injector that is equipped with two inlet throttle elements and two outlet throttle elements, by means of a suitable circuit combination of the throttle elements with one another. Also in this general variant embodiment, one of the outlet throttle elements always remains downstream in the valve chamber of the multi-position valve. As noted already above, the multi-position valve may be a 3/3-way valve, and injection course shaping is effected in particular by means of the combination of the further outlet throttle element either in one subvariant received in the mainstream or in another subvariant in the secondary flow conduit. In the general variant embodiment sketched here, a first inlet throttle element always discharges directly into the control chamber that controls the motion of the nozzle needle and tappet assembly in the injector body. The further inlet throttle element in this variant embodiment is disposed such that upon opening it is connected as a bypass around the first outlet throttle element. Thus filling of the control chamber can be effected via two parallel-connectable inlet throttle elements, which makes a fast needle closing speed possible. The injection course shaping is reinforced by the provision that two outlet throttle elements can be switched in a series circuit or in a way that they each act individually.

With this general variant embodiment, especially fast closure of the nozzle needle in the injector body is attainable.

A fuel injector which is produced in accordance with the two general variant embodiments sketched here is distinguished by the fact that it can be produced especially favorably and simply.

### DRAWING

The invention will be described in further detail below in conjunction with the drawing.

Shown are:

FIG. 1, a variant embodiment with an outlet throttle downstream of a control chamber, a further outlet throttle in the secondary flow conduit, and an inlet throttle in the valve chamber;

FIG. 2, a variant embodiment with a first outlet throttle element received in the primary flow conduit and an inlet throttle discharging into the control chamber;

FIG. 3, a variant embodiment of FIG. 2, with an inlet throttle discharging into the valve chamber;

FIG. 4, a variant embodiment with an inlet throttle discharging into the primary flow conduit;

FIG. 5, a control chamber, which is subjected to control volume via an inlet throttle discharging into it, and downstream of which is an outlet throttle, with a further inlet throttle discharging into the valve chamber;

FIG. 6, a variant embodiment of FIG. 5, with a further inlet throttle element discharging into the secondary flow conduit;

FIG. 7, a variant embodiment of FIG. 3, with a further outlet throttle element received in the primary flow conduit and a further inlet throttle discharging above it; and

FIG. 8, a variant embodiment as shown in FIG. 7, with a further inlet throttle element discharging into the valve chamber of the multi-position valve.

### VARIANT EMBODIMENTS

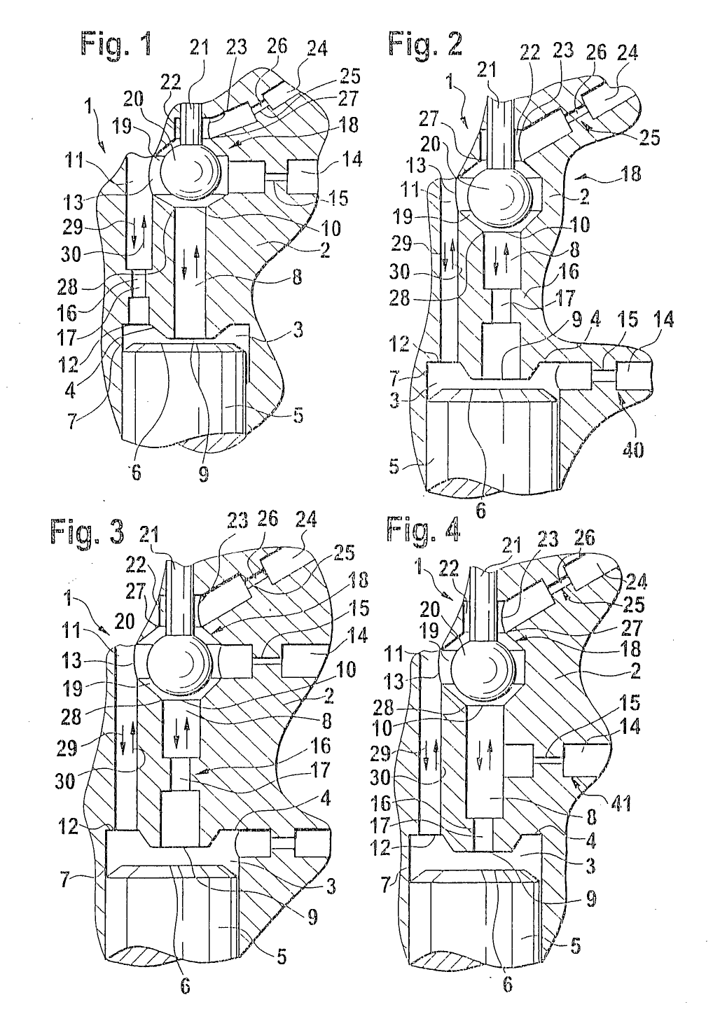

FIG. 1 shows a variant embodiment with an outlet throttle element, connected downstream of a control chamber; a further outlet throttle element in the secondary flow conduit; and an inlet throttle discharging into the valve chamber of a multi-position valve.

An injector for injecting fuel into the combustion chamber of an internal combustion engine includes an injector body 2, in which a control chamber 3 is embodied. The control chamber 3 is defined on one end by a control chamber ceiling 4 of the injector body 2 and on the other by an end face 6 of a nozzle needle and tappet assembly 5. The control chamber 3 is also defined by a control chamber wall 7 of the injector body 2. The control chamber 3 is in communication with a valve chamber 19 of a multi-position valve 18 via a first flow conduit, that is, the primary flow conduit 8, via an orifice 9 toward the control chamber and an orifice 10 toward the valve chamber. The multi-position valve 18 is preferably embodied as a 3/3-way valve. The control chamber 3 also communicates with the valve chamber 19 of the multi-position valve via a second flow conduit 11, that is, the secondary flow conduit. The orifice of the flow conduit 11 on the side toward the control chamber is identified by reference numeral 12, while the orifice of the secondary flow conduit 11 on the side toward the valve chamber is identified by reference numeral 13. Both the primary flow conduit 8 and the secondary flow conduit 11 between the control chamber 3 and the valve chamber 19 can experience flows of fuel through them in both flow directions 29 and 30.

The valve chamber 19, in which a closing body 20, configured spherically as shown in FIG. 1, is received, communicates with a first inlet 14 on the high-pressure side via a first inlet throttle element 15. An outlet throttle element 16 is disposed in the secondary flow conduit 11 and has a cross-sectional area 17 (A₂).

Above the spherically configured closing body 20 of the multi-position valve 18, a transmission element 21 acting on the closing body 20 is shown, which is actuatable via an actuator—either a piezoelectric actuator or a magnet valve—not shown in further detail here. Between the jacket face of the transmission element 21 and the wall of the injector body 2, an annular gap 22 is embodied, from which a branch 23 extends in the direction of an outlet 24. In the outlet 24, downstream of the branch 23, a further outlet throttle element 25 is embodied, which is embodied with a cross-sectional area A₁. The valve body 20 of the multi-position valve 18 can be switched back and forth by means of the transmission element 21 between a first seat 27 and a further, second seat 28. To attain injection course shaping, the first outlet throttle element 16, which in the view shown in FIG. 1 is received in the secondary flow conduit 11, is provided with a cross-sectional area A₁ that is smaller than the cross-sectional area 26 A₂ of the further outlet throttle element.

When the valve body 20 of the multi-position valve 18 has been placed in the second valve seat 28, the first outlet throttle element 16 received in the secondary flow conduit 11, that is, the first outlet throttle element in terms of the outflow direction 30 of the control volume from the control chamber 3, and the further outlet throttle element 25, subjected with the control volume to be discharged via the valve chamber 19, act in series in the outlet 24. When the outlet throttle elements 16 and 25 are connected in series, very good injection course shaping, in accordance with the dimensioning of the throttle cross sections A₁ 17 and A₂ 26, configured flow faces can be attained.

In FIG. 2, a variant embodiment is shown with a first outlet throttle element received in the primary flow conduit and an inlet throttle element discharging directly into the control chamber.

In this variant embodiment as well, the valve chamber 19 of the multi-position valve 18 and the control chamber 3 in the injector body 2 communicate, via two parallel flow conduits, that is, the primary flow conduit 8 and the secondary flow conduit 11. The valve body 20 of the multi-position valve 18 is movable by means of a transmission element 21 between a first valve seat 27 and a second valve seat 28 above the primary flow conduit 8. From the annular gap 22, which the transmission element 21 actuates in order to trigger the valve body 20, an outlet 24 branches off at the branching point 23, with which the further outlet throttle element 25 having the cross-sectional area A₂ identified by reference numeral 26 is integrated. Unlike what is shown in FIG. 1, the control chamber 3 is supplied with fuel directly from a first inlet 14 on the high-pressure side by means of a permanently operative inlet throttle 14. In addition, the first outlet throttle element 16, in contrast to what is shown in FIG. 1, is integrated with the primary flow conduit 8.

In this variant embodiment, the first outlet throttle element 16, received in the primary flow conduit 8, and the further outlet throttle element 25, received in the outlet 24, act parallel to one another. Also in this variant embodiment, the cross-sectional area 17 A₁ of the first outlet throttle element 16 is located below the cross-sectional area 26 A₂ of the further outlet throttle element.

FIG. 3 shows a variant embodiment as in FIG. 2, but with a permanently operative inlet throttle discharging into the valve chamber.

This variant embodiment differs from that of FIG. 2 only in that the permanently operative first inlet throttle element 15 of the first inlet 14 on the high-pressure side does not discharge directly into the control chamber 3, but rather laterally into the valve chamber 19, surrounding the valve body 20 of the multi-position valve 18, in the injector body 2. Accordingly, the primary flow conduit 8 has a flow through it of the control volume both in the inlet direction 29—in terms of the control chamber 3—and in the outlet direction 30. The orifices toward the control chamber of the primary flow conduit 8 and secondary flow conduit 11 are identified by reference numerals 9 and 12, analogously to what is shown in FIGS. 2 and 3, while the orifices 10 and 13 toward the valve chamber of the primary flow conduit 8 and secondary flow conduit 11 are identified by reference numerals 10 and 13, respectively, analogously to the preceding drawings.

FIG. 4 shows a variant embodiment with a permanently operative inlet throttle element discharging into the primary flow conduit between the valve chamber and the control chamber.

In this variant embodiment of the concept on which the invention is based, the first outlet throttle element 16 is disposed with its cross-sectional area 17 (A₁) immediately downstream of the orifice 9 toward the control chamber in the control chamber ceiling 4. Unlike what is shown in FIGS. 1 and 2, the permanently operative inlet throttle element 15 is located in a second, further inlet position, identified by reference numeral 41. The first outlet throttle element 16 received in the primary flow conduit 8 experiences a flow through it—with reference to the control chamber 3—in the inlet direction 29 and outlet direction 30; the permanently operative inlet throttle element 15 should be considered primarily as a leakage quantity limiter, since the actual inlet throttle function is taken over by the first outlet throttle element 17, through which the flow is backward—that is, in the inlet direction 29. In this variant embodiment as well, a branch 23 is associated with an annular gap 22 above the valve chamber 19 of the multi-position valve 18 and changes over into an outlet 24, with which a further outlet throttle element 25 is integrated. The cross-sectional area 26 A₂ of the further outlet throttle element 25 is larger than the cross-sectional area A₁ 17 of the first outlet throttle element 16, which in this variant embodiment is received in the primary flow conduit 8 and can have a flow through it of the control volume in both directions 29 and 30.

It is a common feature of the variant embodiments shown in FIGS. 1-4 that when the valve body 20 of the multi-position valve 18 is in position on its first seat 27 in the injector body 2, the control chamber 3 is filled by the high pressure prevailing in the inlet 14 on the high-pressure side, and the nozzle needle and tappet assembly 5 is kept in its closing position. The filling of the control chamber takes place through the first inlet throttle element 15, which is disposed at different points in the variant embodiments shown here. Very good injection course shaping can be attained particularly with the variant embodiments of FIGS. 1 and 4, in which both the as first outlet throttle elements 16 and the further outlet throttle element 25 are connected in series.

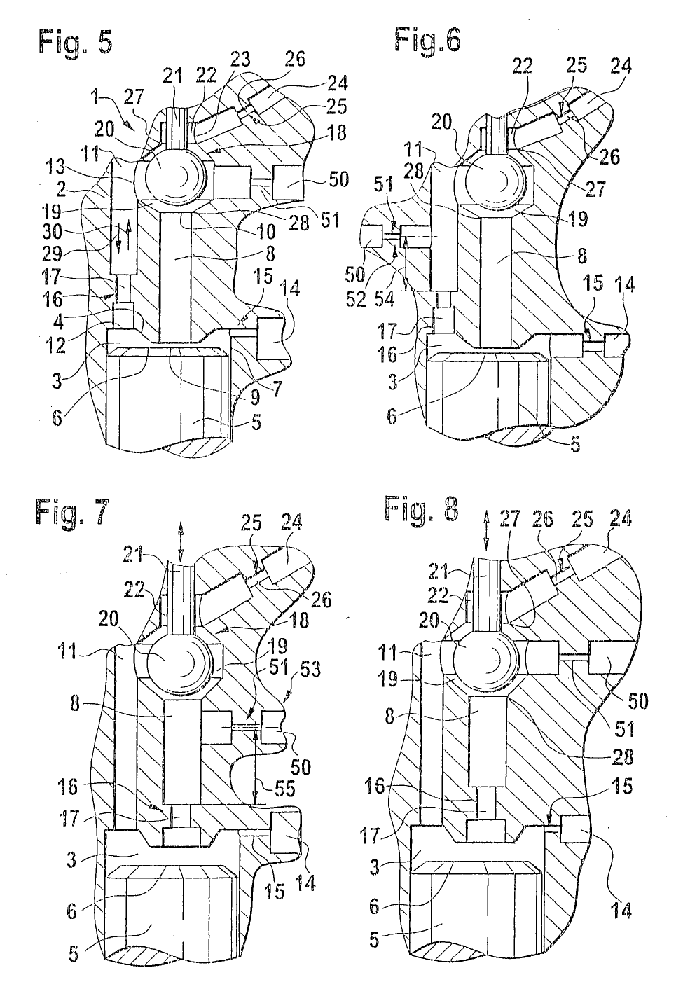

FIG. 5 shows a further general variant embodiment of a fuel injector, with a control chamber which is subjected to pressure via a permanently operative inlet throttle discharging into it, and downstream of the valve chamber is an outlet throttle, and a first inlet throttle element 15 discharges into the valve chamber.

In FIGS. 5, 6, 7 and 8 described below, once again a further outlet throttle element 25 with a cross-sectional area 26 A₂ is connected downstream of the valve chamber 19 of the multi-position valve 18 in each case, and it is received in the outlet 24, which branches off from the annular gap 22.

Moreover, in the variant embodiments shown in FIGS. 5, 6, 7 and 8, the control chamber 3 embodied in the injector body 2 of the injector 1 is filled directly via a permanently operative first inlet throttle element 15, which in turn is subjected to pressure from a first inlet 14 on the high-pressure side. A further feature in common is that in the variant embodiments described below of the concept on which the invention is based, both the control chamber 3 and the valve chamber 19 of the multi-position valve 18 communicate with one another via two flow conduits, that is, the primary flow conduit 8 and the secondary flow conduit 11. The primary flow conduit 8 can be closed by the valve body 20, which in the variant embodiments below is embodied spherically, of the multi-position valve 18 as it moves into the second valve seat 28, and can also be opened again by an actuator, not shown, upon actuation of the transmission element 21.

In the variant embodiment of FIG. 5, a first outlet throttle element 16 is received between the valve chamber 19 of the multi-position valve 18 and the control chamber 3. The secondary flow conduit 11 can have a flow of flow volume through it both in the inlet direction 29 and the outlet direction 30, relative to the control chamber 3. Analogously to the variant embodiments shown in FIGS. 1-4, the control-side end of the primary flow conduit is identified by reference numeral 9, and its orifice toward the valve chamber is identified by reference numeral 10, while the end toward the control chamber of the secondary flow conduit 11 is identified by reference numeral 12, and its end toward the valve chamber is identified by reference numeral 13. In the exemplary embodiment shown in FIG. 5, a further inlet throttle element 51, which is in communication with a further inlet 50 on the high-pressure side, discharges into the valve chamber. If in this variant embodiment, the valve body 20 of the multi-position valve 18 is put in its first seat 27, fast filling of the control chamber is effected via the parallel-acting inlet throttle elements 15 and 51, and in this circuit variant the control chamber is subjected to pressure via the secondary flow conduit 11, the primary flow conduit 8, and the permanently operative first inlet throttle element 15. The first outlet throttle element, received in the secondary flow conduit 11, experiences a flow through it in the reverse direction when the valve body 20 of the multi-position valve 18 is placed in its first valve seat 27; accordingly, a fast closure of the nozzle needle/needle assembly 5, because the control chamber 3 that acts on the face end 6 of the nozzle needle and tappet assembly is additionally filled via a further inlet throttle element 51, which in this case discharges into the valve chamber 19 of the multi-position valve 18, and accordingly a faster pressure buildup takes place in the control chamber 3. In the variant embodiment of FIG. 5, the further inlet throttle element 51 acts as a bypass around the first outlet throttle element 16 received in the secondary flow conduit 11, and when the valve body 20 is moved into the first valve seat 27, a parallel circuit of the two inlet throttle elements 15 and 51 is brought about.

In this variant embodiment, the capability of injection course shaping exists because, with the valve body placed in the second valve seat 28—suitably controlled by the actuator that actuates the transmission element 21—a pressure relief of the control chamber 3 takes place via the series-connected outlet throttle elements, that is, the first outlet throttle element 16 received in the secondary flow conduit 11 and the further outlet throttle element 25, which can be connected in series with it, into the outlet 24 connected downstream of the valve chamber 19. The injection course shaping can be characterized and adjusted by means of how the throttle cross sections 17 and 26, respectively, of the first outlet throttle element 16 in the secondary flow conduit 11 and of the further outlet throttle element 25 in the outlet 24 are embodied.

FIG. 6 shows a variant embodiment as shown in FIG. 5, with a further inlet throttle element discharging into the secondary flow conduit.

In this variant embodiment as well, the control chamber 3 in the injector body is filled via a permanently operative first inlet throttle element 15 directly via a first inlet 14 on the high-pressure side. Analogously to the embodiment of the primary flow conduit 8 and the secondary flow conduit 11 in the variant embodiment of FIG. 5, in the variant embodiment shown in FIG. 6 a first outlet throttle element 16 is received in the secondary flow conduit 11. Downstream of the valve chamber of the multi-position valve is an outlet 24, which includes a further outlet throttle element 25, embodied with the cross section 26 A₂. Unlike the variant embodiment of FIG. 5, the further inlet throttle element 51 of a further inlet 50 on the high-pressure side now discharges not into the valve chamber 19 but rather into the secondary flow conduit 11, at a first spacing 54 from the first outlet throttle element 16 disposed in the secondary flow conduit 11. The spacing 54 in the variant embodiment of FIG. 6 is dimensioned such that in the region of the orifice point of the further inlet throttle element 51 and the end of the first outlet throttle element 16 in the secondary flow conduit 11, the flow can once again become laminar.

If the valve body 20 in the valve chamber 19 is put into its first seat 27, a parallel connection of the first inlet 14 on the high-pressure side and the further inlet 50 on the high-pressure side along with the inlet throttle elements 15 and 51, respectively, received in them is brought about, so that in this variant embodiment as well, the control chamber 3 is subjected to pressure parallel via two inlets, and thus a fast pressure buildup can be achieved, which leads to a fast needle closure. Once again, the further inlet 50 on the high-pressure side is embodied as a bypass around the first outlet throttle element 16 that is downstream of the control chamber 3.

When the valve body 20 of the multi-position valve is put in the second valve seat 28, a pressure relief of the control chamber 3 takes place, via the series-connected outlet throttle elements 16 in the secondary flow conduit 11 and the further outlet throttle element 25 in the outlet 24 downstream of the valve chamber 19.

In the variant embodiment of FIG. 7, a modification of the variant embodiment of FIG. 5 is shown, with a further outlet throttle element received in the mainstream and a further inlet throttle element discharging above it in the primary flow conduit.

In this variant as well, the control chamber 3 is always subjected to control volume directly through a permanently operative first inlet throttle element 15, via a first inlet 14 on the high-pressure side. Downstream of the control chamber 19 is an outlet 24, in which a further outlet throttle element 25 is received that has a cross section 26 A₂. Unlike the variant embodiment shown in FIG. 5, the first outlet throttle element 16 downstream of the control chamber is received not in the secondary flow conduit 11 but in the primary flow conduit 8, which can be opened and closed by the valve body 20 of the multi-position valve 18 in the valve chamber 19.

In this variant embodiment, in which the further inlet throttle element 51 of the further inlet 50 on the high-pressure side discharges into the primary flow conduit 8 at a second spacing 55 from and above the first outlet throttle element 16, filling of the control chamber 3 takes place with the valve body 20 that closes the primary flow conduit 8, via the parallel-acting inlet throttle elements 15 and 51 and the inlets 14 and 50, respectively, on the high-pressure side that act on them. A pressure relief of the control chamber 3 is effected, in the variant embodiment of the injector shown in FIG. 7, with the valve body 20 put in the second valve seat, via the further outlet throttle element received in the outlet 24. The first outlet throttle element 16, received in the primary flow conduit 8, is not operative, since the primary flow conduit 8 is closed upon pressure relief of the control chamber, and so the pressure relief of the control chamber 3 is effected via the primary flow conduit 11, valve chamber 19, and further outlet throttle element 25 of the outlet 24.

In FIG. 8, a slight modification of the variant embodiment of FIG. 7 is shown. Unlike what is shown in FIG. 7, the further inlet 50 on the high-pressure side and the further inlet throttle element 51 integrated with it do not discharge directly into the primary flow conduit 8 but rather into the valve chamber 19 of the multi-position valve. Analogously to what FIG. 7 shows, the first outlet throttle element 16, embodied with a first cross section A₁ 17, is contained in the primary flow conduit 8. The outlet 24 is downstream of the valve chamber 19 of the multi-position valve and includes the further outlet throttle element 25, embodied with the cross section A₂. If the valve body 20 of the multi-position valve is put in its first valve seat 27, then the control chamber 3 is subjected to pressure, on the one hand via the first inlet throttle element 15 that permanently fills it via the first inlet 14 on the high-pressure side, and via the further inlet throttle element 51, discharging into the valve chamber 19, of a further inlet 50 on the high-pressure side. Thus the control chamber is filled via the secondary flow conduit 11 and the primary flow conduit 8, and the first outlet throttle element 16 received in the primary flow conduit 8 in the variant embodiment of FIG. 8 actually functions as an inlet throttle.

Conversely, if the valve body 20 of the multi-position valve in the valve chamber 19 is put against its second seat 28, then the primary flow conduit 8 is closed, and a pressure relief of the control chamber is effected via the secondary flow conduit 11 into the outlet 24, downstream of the valve chamber 19 of the multi-position valve 18, is received.

In the variant embodiments shown in FIGS. 5, 6, 7 and 8, the injection course shaping capability of the injector 1 is achieved by providing that, in the variant embodiments of FIGS. 5 and 6, upon pressure relief of the control chamber 3, the first outlet throttle element 16 of the secondary flow conduit 11 and the further outlet throttle element 25 of the outlet 24, which is connected downstream of the control chamber 19, act in series, and in accordance with the embodiment of the throttle cross sections A₁ 17 and A₂ 26, an injection course shaping is attainable, while in the variant embodiments embodied in FIGS. 7 and 8, the pressure relief of the control chamber 3 takes place, with the valve body 20 of the multi-position valve 18 put in the second valve seat 28, via the secondary flow conduit 11, the valve chamber 19, into the further outlet throttle element 25, which in these cases acts individually, in the outlet 24.

In the variant embodiments in FIGS. 5-8, when the valve body 20 of the multi-position valve 18 has been put in its second valve 28, filling of the control chamber 3 takes place parallel, via the permanently operative first inlet throttle element 15 and the first inlet 18 on the high-pressure side as well as the further inlet throttle element 51 and the further inlet 50 on the high-pressure side, which in the variant embodiments 5, 6, 7 and 8 can discharge at different points, that is, into the valve chamber 19, the secondary flow conduit 11, or the primary flow conduit 8.

1-14. (canceled)

15. A fuel injector for injecting fuel into the combustion chamber of an internal combustion engine, the injector comprising:
a multi-position valve (18) that includes a valve body (20) received in a valve chamber (19), and upon actuation of the multi-position valve (18),
a control chamber (3) disposed in the injector body (2) which can be pressure-relieved or subjected to pressure upon activation of the multi-purpose valve (18)
the control chamber (3) being subjectable to pressure via at least one inlet throttle element (15) and pressure-relievable via at least one outlet throttle element (16),
a further outlet throttle element (25),
the valve chamber (19) of the multi-position valve (18) being connected downstream of the further outlet throttle element (25), and
the valve chamber (19) and the control chamber (3) being in communication with one another via a primary flow conduit (8) and a secondary flow conduit (11).

16. The fuel injector of claim 15, wherein the multi-purpose valve (18) further comprises a valve body (20) and first and second valve seats (27, 28), the primary flow conduit (8) being closable by the valve body (20) at the second valve seat (28).

17. The fuel injector of claim 15, wherein the first outlet throttle element (16) is disposed in the secondary flow conduit (11).

18. The fuel injector of claim 15, wherein the first outlet throttle element (16) is disposed in the primary flow conduit (8).

19. The fuel injector of claim 15, wherein the first outlet throttle element (16) has a smaller cross section (17) than the cross section (26) of the further outlet throttle element (25) downstream of the valve chamber (19).

20. The fuel injector of claim 18, wherein the permanently operative first inlet throttle element (15) discharges into the primary flow conduit (8) above the first outlet throttle element (16).

21. The fuel injector of claim 17, wherein the permanently operative first inlet throttle element (15) discharges into the valve chamber (19) of the multi-position valve (18).

22. The fuel injector of claim 18, wherein the permanently operative first inlet throttle element (15) discharges directly into the control chamber (3).

23. The fuel injector of claim 21, wherein a further inlet throttle element (51) discharges directly into the control chamber (3).

24. The fuel injector of claim 17, wherein the permanently operative inlet throttle element (15) discharges above the first outlet throttle element (16), and the control chamber (3) can be subjected to pressure via a further inlet throttle element (51).

25. The fuel injector of claim 24, wherein the permanently operative first inlet throttle element (15) discharges into the secondary flow conduit (11) at a first spacing (54) from the first outlet throttle element (16).

26. The fuel injector of claim 17, wherein the permanently operative first inlet throttle element (15) discharges into the primary flow conduit (8) above the first outlet throttle element (16), and wherein the control chamber (3) can be subjected to pressure via a further inlet throttle element (51).

27. The fuel injector of claim 20, wherein the permanently operative throttle element (15) is disposed such that it discharges into the primary flow conduit (8) at a second spacing (5) from the first outlet throttle element (16).

28. The fuel injector of claim 18, wherein the permanently operative inlet throttle element (15) communicates fluidically directly with the valve chamber (19) of the multi-position valve (18), and the further inlet throttle element (51) communicates fluidically directly with the control chamber (3).
